(19) United States
(12) Patent Application Publication
(10) Pub. No.: US 2026/0101199 A1
(43) Pub. Date: Apr. 9, 2026

(54) CELLULAR NETWORK CONFIGURATION FOR EMERGENCY SERVICE OPTIMIZATION

(71) Applicant: AT&T Intellectual Property I, L.P., Atlanta, GA (US)

(72) Inventors: Timothy A. Wysocki, Berlin, MA (US); Jewel Burleson, Dallas, TX (US)

(21) Appl. No.: 18/906,987

(22) Filed: Oct. 4, 2024

(51) Int. Cl. H04W 24/02; H04B 17/318; H04W 4/90

(52) U.S. Cl. CPC H04W 24/02; H04B 17/318; H04W 4/90

(57) ABSTRACT

A processing system may identify land coverage characteristics of areas within a region and identify network characteristics of the areas associated with a wireless communication network, the network characteristics including wireless signal strength and emergency service call characteristics. The processing system may next assign emergency service priority scores to the areas using a scoring model that assigns a first weight to the respective area based upon a land coverage characteristic of the area and that assigns a second weight to the respective area based upon a respective wireless signal strength characteristic of the area and a respective emergency service call characteristic of the area, where the emergency service priority score may comprise a combination of the first and second weights. The processing system may then perform at least one network configuration action in the wireless communication network based upon at least one of the emergency service priority scores.

The present disclosure relates generally to wireless communication networks, and more particularly to methods, non-transitory computer-readable media, and apparatuses for performing at least one network configuration action in a wireless communication network based upon at least one emergency service priority score that is assigned to at least one of a plurality of areas within a region in accordance with a scoring model.

### BACKGROUND

First responders (e.g., firefighters, police, emergency medical service (EMS) personnel, etc.) and/or governmental or quasi-governmental entities (e.g., military, public health entities, hazardous materials (hazmat) units, etc.) may be entitled to access and utilize a priority network, or priority network slice(s) of a cellular network that are configured for use by these entities and their personnel.

Such a priority network, or priority network slice(s) may be used for two-way communication involving systems and/user endpoint devices associated with these entities, where reliability of such communications may be of heightened importance. In addition, the Wireless Emergency Alert (WEA) system is capable of providing messages indicative of a variety of types of alerts. Via the WEA system, mobile devices can receive messages pertaining to weather conditions, disasters, child abduction America's Missing: Broadcast Emergency Response (AMBER) alerts, and any alerts for imminent threats to life or property issued by authorized government entities, for example. However, in some cases, a WEA message may not be received by endpoint devices in an alert area due to the lack of proper network coverage, poor signal reception, an endpoint device being set to airplane mode, or off, and so forth.

### SUMMARY

In one example, the present disclosure discloses a method, computer-readable medium, and apparatus for performing at least one network configuration action in a wireless communication network based upon at least one emergency service priority score that is assigned to at least one of a plurality of areas within a region in accordance with a scoring model. For example, a processing system including at least one processor may identify land coverage characteristics of a plurality of areas within a region. The processing system may also identify network characteristics of the plurality of areas associated with a wireless communication network, wherein the network characteristics include wireless signal strength characteristics and emergency service call characteristics. The processing system may next assign a plurality of emergency service priority scores to the plurality of areas, where a respective emergency service priority score is assigned to each respective area of the plurality of areas using a scoring model that assigns a first weight to the respective area based upon a respective land coverage characteristic of the respective area and that assigns a second weight to the respective area based upon a respective wireless signal strength characteristic of the respective area and a respective emergency service call characteristic of the respective area. The respective emergency service priority score may comprise a combination of at least: the first weight and the second weight. The processing system may then perform at least one network configuration action in the wireless communication network based upon at least one of the plurality of emergency service priority scores.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example aspects of an emergency service priority scoring model, in accordance with the present disclosure;

FIG. 3 illustrates an example emergency service priority score map, in accordance with the present disclosure;

FIG. 4 illustrates a flowchart of an example method for performing at least one network configuration action in a wireless communication network based upon at least one emergency service priority score that is assigned to at least one of a plurality of areas within a region in accordance with a scoring model; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for performing at least one network configuration action in a wireless communication network based upon at least one emergency service priority score that is assigned to at least one of a plurality of areas within a region in accordance with a scoring model. To illustrate, in one example, the present disclosure may access and combine various datasets relating to wireless communications for emergency services and/or public safety to score areas within a region in terms of priority of public safety demand. In one example, the present disclosure may include creating a heat map of a region, such as the United States, regions within the United States (e.g., particular states, or groups of states, etc.), another country, and so forth. In one example, the combination of wireless network proprietary data (e.g., network coverage, customer feedback, 911 calling data, and so forth) with publicly accessible datasets (such as lists of critical infrastructure, census/population data, roads, public safety locations, land use types, risk assessment values (e.g., from Federal Emergency Management Agency (FEMA) risk assessment), etc.) may create a flexible, extensible, and detailed map of areas of high importance to public safety, but which may be underserved by current wireless network configurations. Accordingly, a wireless network may refocus its view of the network from a public safety perspective.

The use of emergency service priority scores in accordance with the present disclosure provides tangible benefits to a wireless network and to parties seeking to provide network services to the public safety community via the wireless network. In particular, a network operator may identify areas important to public safety that would most benefit from network enhancements. In addition, such an emergency service priority scoring model may be used to locate geographic areas with high value and superior network performance, to assess network readiness for service offerings, to locate priority areas for geofenced service offerings and/or in which to utilize geocasting techniques for service delivery, and so forth.

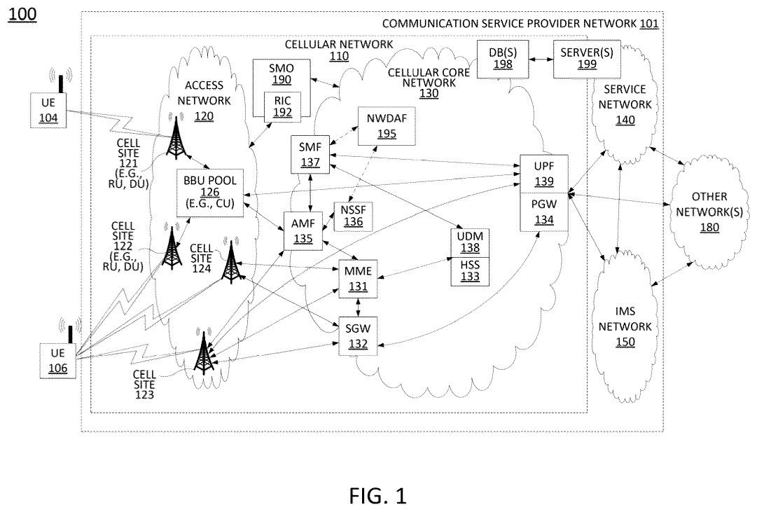

In one example, emergency service priority score information may be displayed and analyzed using a geographic information system (GIS) visualization tool, or tools. Alternatively, or in addition, a dataset of emergency service priority scores may be stored in a relational database, enabling Structured Query Language (SQL) queries or the like, e.g., to select subsets of data and to access the components which are weighted into final emergency service priority scores for respective areas. In one example, such emergency service priority scores may be used as inputs to one or more machine learning models, e.g., along with other datasets to identify additional relationships or trends within the data, and to gain deeper understanding of how geographic features may affect public safety behavior and demand. These and other aspects of the present disclosure are discussed in greater detail below in connection with the examples of FIGS. 1-5.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and/or O-RAN infrastructure may include distributed units (DUs), radio units (RUs)/RRHs and centralized units (CU), e.g., baseband units (BBUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructures. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 195.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 195, which may be tasked with monitoring various network functions, network slices, and access network components. In one example, NWDAF 195 may subscribe to data analytics (e.g., performance indicators/KPIs) from a variety of NFs, may store these analytics, and may provide such analytics to other NFs that may request such data. For instance, NSSF 136 may obtain slice load level analytics which may be used by NSSF 136 to select a network slice or network slices to serve an endpoint device, or may indicate one or more network slices that are permitted to be selected to serve an endpoint device. For instance, AMF 135 may query NSSF 136 for one or more network slices in response to a request from an endpoint device to establish a session to communicate with a PDN (e.g., which may be represented by other network(s) 180 in FIG. 1). The NSSF 136 may provide the selection to AMF 135, or may provide one or more permitted network slices to AMF 135, where AMF 135 may select the network slice from among the choices. In one example, AMF 135 may utilize additional information such as a UE/subscriber class or category from HSS 133. For example, when a slice is indicated to have a particular load level above a threshold, UEs/subscribers of one or more defined classes/categories may be prevented from accessing the slice, or may have preferential access to the slice over other classes/categories, and so forth. In one example, NWDAF 195 may track various performance indicators with respect to access network 120 and/or regarding particular components thereof (such as RUs, DUs, CU, etc., e.g., cell sites 121 and 122, BBU pool 125, cell sites 123 and 124, and so forth).

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”).

For instance, in non-standalone (NSA) mode architecture, LTE radio equipment may continue to be used for cell signaling and management communications, while user data may rely upon a 5G new radio (NR), including millimeter wave communications, for example. However, the example of FIG. 1 may depict a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 195, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 195, and/or UPF 139, and other components of system 100 are also omitted for clarity, such as additional routers, switches, gateways, and the like. In one example, SMO 190 may include a RAN intelligent controller (RAN-IC or RIC) 192. For instance, in an O-RAN architecture, the RIC 192 may be deployed for managing and controlling various RAN components/functions, e.g., CUs, DUs, and RUs. For instance, as noted above, RIC 192 may comprise a platform that hosts various RAN applications that may be used to configure and reconfigure various components of access network 120. In one example, aspects of RIC 192 may represent functionality of an SON orchestrator, or vice versa.

In one example, RIC 192 and/or SMO 190 may request and/or subscribe to various information that may be obtained and stored by NWDAF 195. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 192 and/or SMO 190 may obtain various information from RAN components or other network elements directly (e.g., without NWDAF 195 as an intermediary). In one example, SMO 190 may comprise a computing platform/system hosting various RAN applications, which may comprise programs, code, etc. running on computing hardware of the SMO 190.

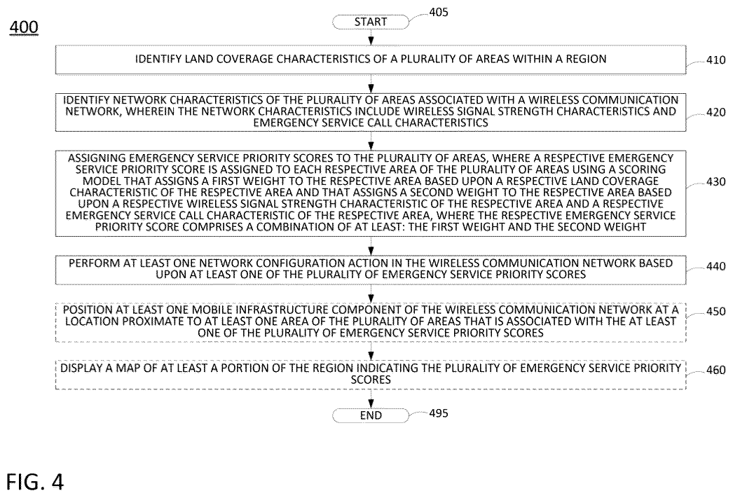

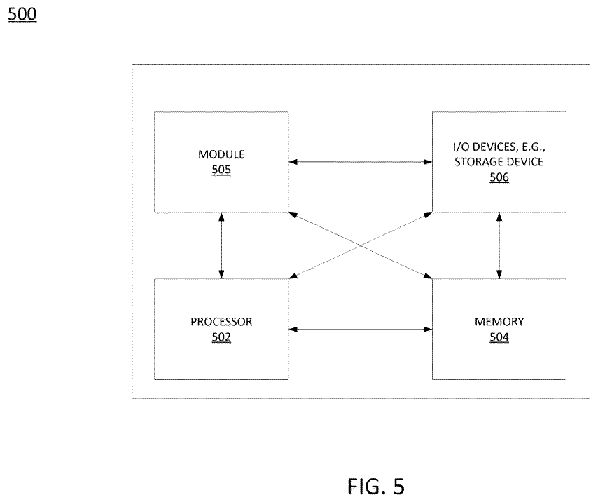

In one example, communication service provider network 101 may include server(s) 199. For instance, aspects of the present disclosure for performing at least one network configuration action in a wireless communication network based upon at least one emergency service priority score that is assigned to at least one of a plurality of areas within a region in accordance with a scoring model, e.g., as described in greater detail below in connection with the example method 400 of FIG. 4, may be performed by server(s) 199. In this regard, in one example, server(s) 199 may comprise all or a portion of a computing device or system, such as computing system 500, and/or processing system 502 as described in connection with FIG. 5 below, and may be configured to perform various operations in connection with examples of the present disclosure for performing at least one network configuration action in a wireless communication network based upon at least one emergency service priority score that is assigned to at least one of a plurality of areas within a region in accordance with a scoring model. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

In one example, communication service provider network 101 may also include one or more databases (DBs) 198, e.g., physical storage devices integrated with server(s) 199 (e.g., database servers), attached or coupled to the server(s) 199, and/or in remote communication with server(s) 199 to store various types of information in connection with examples of the present disclosure. For instance, DB(s) 198 may store various data pertaining to wireless communications services for first responders/emergency services and/or other governmental interests. As just one example, DB(s) 198 may be configured to receive and store network operational data collected from the communication service provider network 101, such as call logs, mobile device location data, control plane signaling and/or session management messages, data traffic volume records, call detail records (CDRs), error reports, network impairment records, performance logs, alarm data, subscriber/account records, and other information and statistics, which may then be compiled and processed, e.g., normalized, transformed, tagged, etc., and forwarded to DB(s) 198.

In one particular example, DB(s) 198 may receive, create, and/or store network operational data comprising wireless signal strength information for various areas. For instance, in one example, areas may be uniform polygons, such as hexagons (or any other shapes), with the same dimensions. For instance, in one example, a basic unit of area may comprise an R8 (resolution 8) hexagon, e.g., according to an H3 geospatial indexing system, where each side may be approximately ½ kilometer (e.g., approximately 531 meters, with an area of approximately 0.737 square kilometers). In one example, the wireless signal strength information may comprise an average that may be collected from measurements over a defined time period, such as the last 48 hours, the last 10 days, etc. In one example, the wireless signal strength information may be derived from measurements by endpoint devices, such as UEs 104 and 106, which may be reported to respective cell sites, such as cell sites 121-123, as part of UE attach and/or handover procedures. For instance, UEs 104, 106 and others may collect reference signal received power (RSRP), reference signal received quality (RSRQ), or received signal strength indicator (RSSI) measurements (and/or all of which may comprise “wireless signal strength information”) and report to the cellular network 110 via respective cell sites. It should be noted that the areas over which wireless signal strength information is collected and stored do not correspond to “cells,” or specific coverage areas that are often illustrated as hexagons. Thus, not all areas will include a cell site. In one example, the wireless signal strength measurements may be loaded to NWDAF 195 and copied to DB(s) 198. However, in another example, server(s) 199 and/or DB(s) 198 may subscribe to these measurements directly (e.g., without NWDAF 195 as an intermediate repository).

In one example, DB(s) 198 may obtain and store additional network operational data and external data comprising geographic information. In one example, the external data may also include 3^{rd} party network monitoring data relating to cellular network 110 and/or the communication service provider network 101. In particular, DB(s) 198 may store various types of data relevant to wireless communications services for first responders/emergency services and/or other governmental interests. For instance, DB(s) 198 may store various types of data in support of a scoring model that may be implemented by server(s) 199 to generate emergency service priority scores for various areas, e.g., R3 hexagons, or the like.

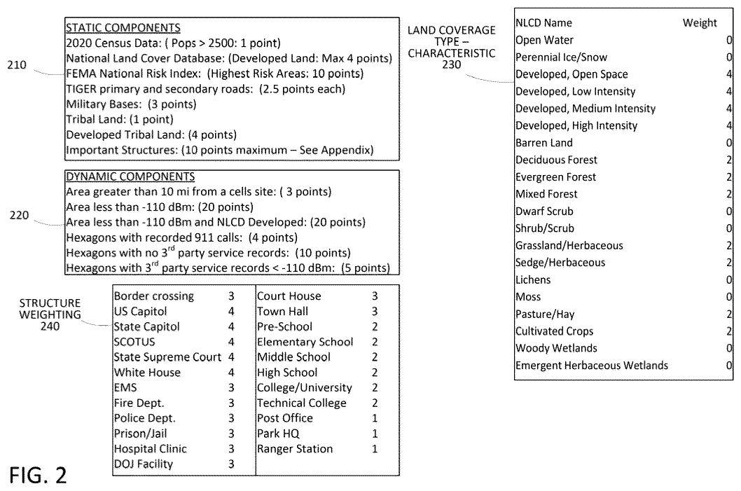

To further illustrate, FIG. 2 provides several aspects of an emergency service priority scoring model in accordance with the present disclosure. For example, a processing system of the present disclosure (such as server(s) 199 of FIG. 1) may implement an emergency service priority scoring model that generates/assigns an emergency services priority score to a given area that combines weights from static components 210 and from dynamic components 220. For instance, as shown in FIG. 2, static components 210 may include a first component/factor for population. For example, the population factor may utilize 2020 census data (or other most up-to-date census/population information). In the present example, an area may be assigned a weight of “1” for this factor when the population of the area is greater than 2,500. However, a weight of zero may be assigned when the area has a population of less than or equal to 2,500. It should be noted that this is just one example of how a population factor weight may be assigned and that other, further, and different examples may assign a weight to an area in accordance with a population factor using a different threshold, a different formula, or the like. For instance, in another example, the threshold may be set to 2,000, may be set to 3,000, etc. Alternatively, or in addition, different weights may be assigned according to a formula as a function of the population, e.g., a weight of zero for population less than 2,000, a weight of “1” for population between 2,000 and 4,000, and a weight of “2” for population over 4,000, or the like. In this regard, it should be noted that DB(s) 198 may store census or other data, e.g., which may be obtained from publicly-accessible server(s), data-feed(s), etc.

In addition, in the example of FIG. 2, a second static component/factor may be a land coverage type, or “land coverage characteristic.” For example, a National Land Coverage Database (NLDB) may include records of land coverage type/characteristic for various areas, which may also be obtained and stored by DB(s) 198. In one example, the NLDB may provide data based upon dynamically selectable areas/area sizes. For instance, land coverage data may be available at different granularities/resolutions. In one example, a land coverage type of a point under a centroid of an area (e.g., an R8 hexagon) may be treated as the land coverage type of the area. In one example, a maximum weight of “4” points may be assigned to an area based upon its land coverage type/characteristic. To further illustrate, FIG. 2 includes an example list of land coverage types/characteristics 230 and corresponding weights. For instance, developed land coverage types (e.g., developed/open space, developed/low intensity, developed/medium intensity, developed/high intensity) may receive the maximum weight of “4” points, while grassland, cropland, and others may be assigned weights of “2” points, while still other land coverage types may be assigned weights of zero, such as open water, barren land, woody wetlands, etc. It should be noted that the land coverage types/characteristics 230 and the corresponding weights are just one example, and that other, further, and different examples may include additional or different land coverage types/characteristics, different weights for one or more of the land coverage types/characteristics, and so on.

Continuing with the static components 210, an additional component/factor may be for a risk index (e.g., a Federal Emergency Management Agency (FEMA) risk index), which may also be obtained and stored by DB(s) 198. In the present example, a maximum weight of “10” points may be assigned based on the FEMA risk index. For example, the FEMA risk index may assign a risk index having a range of five categories: very high, relatively high, relatively moderate, relatively low, and very low. In one example, to map the risk index to weights for an emergency service priority score, a weight of “10” points may be assigned to the “very high” risk category, a weight of “6” points may be assigned to the “relatively high” risk category, a weight of “4” points may be assigned to the “relatively moderate” risk category, a weight of “2” points may be assigned to the “relatively low” risk category, and a weight of zero may be assigned to the “very low” risk category. However, in another example, different weightings may be mapped to the respective FEMA risk index categories.

Still another of the static components 210 may include a roadway factor. For instance, a Master Address File/Topologically Integrated Geographic Encoding and Referencing (MAF/TIGER) database may include information indicating the presence of roads and the road types in various areas. In one example, the presence of roads may be indicated in absolute geographic terms (e.g., with a certain precision/accuracy), which may then be correlated to the bounds of different areas (e.g., R3 hexagons, or the like). As such, the presence or absence of roads in a given area may be determined. In addition, a weight may be assigned to an area based upon the road type(s). For instance, in the example of FIG. 2, an emergency service priority scoring model may assign to an area “2.5” points for a presence of each of a primary road or a secondary road as designated in a TIGER database. It should be noted that in other, further, and different examples, a different database may be used in connection with a roadway factor. For instance, a TIGER database may be supplanted by a future developed database for the same or similar purpose, a private database with similar information may become available, one or more states may maintain similar public databases with respect to roads within a given state, or another publicly available dataset/database may be used for roadways in a different (e.g., non-USA) country.

Other factors/components of the static components may include a factor for the presence of a military base (e.g., “3” points when present in an area, zero otherwise), a factor for the presence of tribal lands (e.g., “1” point when present in an area, zero otherwise), a factor for the presence of tribal land that is developed (e.g., “4” points when present in an area, zero otherwise), and so forth. In addition, in one example, the emergency service priority scoring model may include a factor, or factors for specific designated structures or structure types, such as included in the list of structure weightings 240. In one example, a presence of any one of these structures in an area may result in the inclusion of the corresponding weight in contributing to an emergency service priority score. In one example, a maximum of “10” points may be assigned to an area based upon the presence of such structures. For instance, an area with a border crossing, an EMS facility, a fire department, and a police department may be capped at a maximum contribution of “10” points to the emergency service priority score, even though the emergency service priority scoring model may indicate a total of “12” points if each of these structures was given full weight. In one example, the locations of these structures may be obtained from one or more data sources. In one example, an area's assigned weight with respect to specific designated structures may relate to structure(s) within the bounds of the area. However, in another example, all areas within a defined distance of a specific designated structure may have a weight that is affected by the presence of the structure. In general, the foregoing data points may be obtained by server(s) 199 and/or DB(s) 198 via public access to various databases/data sets may be found at census.gov, data.gov, doi.gov, fema.gov, a Department of Justice (DOJ) website, etc.

In addition to static components 210, an emergency service priority scoring model of the present disclosure may further include dynamic components 220. These dynamic components 220 may primarily relate to network operational data of the cellular network 110 and/or communication service provider network 101. To further illustrate, DB(s) 198 may store an indicator for each area of: a distance of the area from a nearest cell site (or an indicator of whether the area is beyond a threshold distance from a cell site, such as 5 miles, 10 miles, etc.).

Alternatively, or in addition, server(s) 199 may compute such distances using an inventory database of the communication service provider network 101 in conjunction with a geographic map or map database with location information of each area (e.g., a center of the area, the borders of the area, the dimensions of the area, etc.). In one example, server(s) 199 may then compute a weight in accordance with the emergency service priority scoring model based on the computed distance for an area, e.g., “3” points when greater than 10 miles from a nearest cell site, zero otherwise, or the like.

In addition, another of the dynamic components 220 may include a wireless signal strength factor. For instance, as mentioned above, DB(s) 198 may obtain and store wireless signal strength measures, such as an average that may be collected from measurements over a defined look-back time period, such as the last 48 hours, the last 10 days, etc. In one example, and as illustrated in FIG. 2, an emergency service priority scoring model of the present disclosure may then assign a weight based on the wireless signal strength measure, e.g., “20” points for an area less than −110 dBm, or zero for an area greater than or equal to −110 dBm, or the like. It should be noted that in other, further, and different examples, a different threshold may be used, or a formula may be used that includes a range of weights for a range of wireless signal strength measures (for instance, “20” points if an area is less than −110 dBm, “10” points if an area is less than −95 dBm but not less than −110 dBm, zero points otherwise, etc.).

In one example, another of the dynamic components 220 may include a component/factor for a wireless signal strength-plus-land development status. For instance, the wireless signal strength-plus-land development status characteristic may comprise an indication of whether a respective area has: a “developed” development status and a wireless signal strength metric that is below a threshold, e.g., in this example below −110 dBm. In such case, a weight of “20” points may be assigned to an area according to emergency service priority scoring model of the present disclosure (or zero otherwise). It should be noted that this may be an additional component/factor that is distinct from the wireless signal strength metric/characteristic, although wireless signal strength measures may impact both. In the present example, a wireless signal strength threshold of −110 dBm is applied for both characteristics/factors. However, in another example, different thresholds may be used for the respective characteristics/factors.

In one example, an additional one of the dynamic components 220 may include an emergency service call characteristic. For instance, for a given area, the characteristic may include an indication of whether a threshold number of emergency service calls (e.g., 911 calls) have been initiated by endpoint devices from within the area, e.g., over a defined time period, such as the preceding two weeks, a past month, etc. In one example, the threshold may be 1 (one). In other examples, the threshold may be another number of emergency service calls, such as 2, 5, 10, etc. In the example of FIG. 2, if the threshold is exceeded, the emergency service priority scoring model may assign a weight of “4” points (otherwise zero). It should be noted that such a look-back time period may be the same or different from a similar look-back time period that may be used for other characteristics/factors, such as wireless signal strength mentioned above.

Still another one of the dynamic components 220 may include a third party wireless performance record characteristic. For instance, this factor may comprise an indication of whether at least one third party wireless performance record pertaining to a respective area is available (e.g., stored in DB(s) 198 and/or accessible to server(s) 199 from a 3^{rd} party server or servers, etc.). For example, UEs 104 and/or 106 (and other wireless endpoint devices) may gather wireless signal strength measures for cell sites 121-123, and so forth. In addition, these endpoint devices may report these measures to a 3^{rd} party service, e.g., via respective applications (apps) installed on the respective endpoint devices. As such, a 3^{rd} party service may aggregate records that provide average wireless signal strength metrics for different locations and/or areas. Examples of such 3^{rd} party service providers include Ookla, Opensignal, and so forth. In addition, communication service provider network 101 may access such records (and/or store such records in DB(s) 198 or elsewhere) to determine whether any specific records exist that pertain to a given area. If no, a weight of “10” points may be assigned to the area for this component/factor according to an emergency service priority scoring model of the present disclosure (otherwise a weight of zero may be assigned for this characteristic/factor).

Similarly, another characteristic/factor of the dynamic components 220 may include a 3^{rd} party wireless signal strength characteristic/factor. For instance, this factor may be similar to the wireless signal strength characteristic/factor discussed above (and also listed in the dynamic components 220 of FIG. 2), but with respect to the third party service records. In this example, if records exist with respect to a given area and show a wireless signal strength metric of less than −110 dBm, the emergency service priority scoring model may assign a weight of “5” points to the area with respect to this characteristic/factor (otherwise zero). In other examples, the 3^{rd} party wireless signal strength characteristic/factor may employ a different threshold, may be assigned a different weight, may assign a range of different weights according to a range of wireless signal strength metrics (e.g., “5” points for less than −110 dBm, “2” points for less than −95 dBm but not less than −110 dBm, zero otherwise, or the like). It should also be noted that the present example of FIG. 2 illustrates an emergency service priority scoring model that differentiates between 3^{rd} party service records and operational records of the communication service provider network 101 itself. However, in another example, an emergency service priority scoring model may combine these factors, e.g., by averaging the respective wireless signal strength metrics for the area, or via a formula that combines the respective metrics to assign a given weight. In this regard, it should be further noted that the emergency service priority scoring model illustrated in FIG. 2 is just one example, and that other, further, and different examples in accordance with the present disclosure may utilize more or less characteristics/factors, may assign different weights according to different thresholds or other criteria for such factors, and so forth. Thus, these and other modifications are all contemplated within the scope of the present disclosure.

Returning again to a description of FIG. 1, DB(s) 198 may thus obtain and store various network operational data for purposes of emergency service priority scoring, such as information identifying, for each geographic area (such an R8 hexagon, or the like): a number of emergency services calls (e.g., 911 calls), wireless signal strength information, etc. In one example, records may be aggregated and maintained for respective areas, e.g., R8 hexagons or the like.

Thus, for a given area, a record may include wireless signal strength information, emergency services call information, and other items.

In one example, server(s) 199 may access network operational data and non-network data (e.g., geographic data and/or other third party data) stored in DB(s) 198 to then create additional records for respective areas. In addition, server(s) 199 apply an emergency service priority scoring model over the records in DB(s) 198 to assign weights and determine overall emergency service priority scores for various areas in a region (e.g., the United States or sub-regions, such as a state, a set of contiguous states, etc.).

In addition, as noted above, aspects of the present disclosure for performing at least one network configuration action in a wireless communication network based upon at least one emergency service priority score that is assigned to at least one of a plurality of areas within a region in accordance with a scoring model, e.g., as described in greater detail below in connection with the example method 400 of FIG. 4, may be performed by server(s) 199. For instance, server(s) 199 may identify land coverage characteristics of a plurality of areas within a region, e.g., from records within DB(s) 198. In addition, server(s) 199 may identify network characteristics of the plurality of areas associated with a wireless communication network, e.g., from additional records within DB(s) 198, where the network characteristics may include wireless signal strength characteristics and emergency service call characteristics. Server(s) 199 may next assign a plurality of emergency service priority scores to the plurality of areas, e.g., according to an emergency service priority scoring model. For instance, a respective emergency service priority score may be assigned to each respective area of the plurality of areas using a scoring model that assigns a first weight to the respective area based upon a respective land coverage characteristic of the respective area, and that assigns a second weight to the respective area based upon: a respective wireless signal strength characteristic of the respective area and a respective emergency service call characteristic of the respective area. In particular, the respective emergency service priority score may comprise a combination of at least: the first weight and the second weight.

Server(s) 199 may then perform at least one network configuration action in the wireless communication network based upon at least one of the plurality of emergency service priority scores. For example, server(s) 199 may reconfigure at least one component of the cellular network 110 and/or the communication service provider network 101 in response to the at least one of the plurality of emergency service priority scores. To illustrate, server(s) 199 may stage at least one software resource (e.g., media, applications, etc.) at a network edge infrastructure of the wireless communication network proximate to at least one area of the plurality of areas that is associated with the at least one of the plurality of emergency service priority scores (e.g., at server(s) within or near access network 120, etc.). Alternatively, or in addition, server(s) 199 may establish a network slice in response to the at least one of the plurality of emergency service priority scores, e.g., via SMO 190 and/or RIC 192 and/or instructions to BBU pool 126, any one or more of cell site(s) 121-123, etc. For example, establishing a network slice may include reconfiguring CU, DU, or RRH, BBU, etc., where the reconfiguring may include activating a component, if not active, reassigning a component to a slice, or reallocating priority/time-sharing to the slice (versus other slice(s)), and so forth. In one example, the reconfiguring may include adding a carrier at a cell site proximate to at least one area in response to at least one emergency service priority scores (e.g., indicating an area of relatively high demand but with less than optimal current service). Similarly, in one example, the reconfiguring may include adjusting a beam coverage of at least one cell site to favor at least one area with an enhanced public safety demand as indicated by the at least one of the plurality of emergency service priority scores. Likewise, the reconfiguring may further include allocating other resources, such as additional capacity of AMF 135, UPF 139, etc. to “favor” areas with higher scores (and hence greater public safety need/demand (e.g., not currently adequately served by existing network hardware resources and configuration)).

In one example, server(s) 199 may rebroadcast a wireless emergency alert (WEA) message via a cell site proximate to at least one area, e.g., where the rebroadcasting is prioritized for the cell site as compared to other cell sites based upon the emergency service priority score(s). For example, areas with higher scores may indicate areas with an enhanced public safety demand which have limited network coverage. As such, these may be treated as priority areas for rebroadcast of WEA messages to improve the message delivery success rate. In still other examples, a network operator may also deploy new cell sites based upon the plurality of emergency service priority scores, may provide recommendations to first responders as to where to stage equipment and recovery crews in anticipation of demand when natural disaster or public safety events occur, and so forth.

Alternatively, or in addition, server(s) 199 may perform various other operations as described in connection with the example method 400 of FIG. 4 and/or as described elsewhere herein, such as generating and presenting maps or other visualizations, and so forth.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs). In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. In addition, network elements or functions that are illustrating as being deployed in one portion of the communication service provider network 101 may alternatively or additionally be deployed in another portion of the communication service provider network 101. For example, server(s) 199 and/or DB(s) 198 may be deployed in cellular core network 130, within access network 120, within service network 140, or may comprise a distributed computing platform having hardware components distributed across various networks, or sub-networks. Thus, these and other modifications are all contemplated within the scope of the present disclosure.

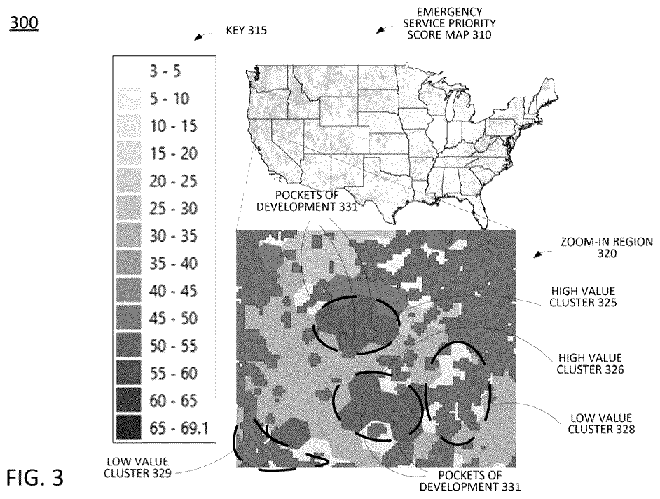

To further aid in understanding the present disclosure FIG. 3 illustrates an example emergency service priority score map 310. For instance, as noted above, server(s) 199 of FIG. 1 may additionally generate and present such a map, e.g., on an endpoint device of network personnel and/or of an emergency service provider, or the like. In the present example, the emergency service priority score map 310 may relate to a region comprising the entirety of the continental United States (e.g., the lower 48 states). Areas may comprise R8 hexagons or the like, where darker tones may indicate areas with higher emergency service priority scores, while lighter tones may indicate areas with lower emergency service priority scores. For example, the key 315 indicates the tones for different scoring bands over an example range of potential scores, e.g., 3 to 69.1. FIG. 3 further illustrates a zoom-in region 320 which may depict an example portion of northern California in more detail. In particular, the zoom-in region 320 may illustrate hexagons comprising “areas” of the present disclosure having different tones relating to the respective scores. In addition, the zoom-in region 320 may include an overlay/layer of developed versus non-developed terrain, e.g., according to an NLCD map. For instance, the darkened rectangular polygons may illustrate such “developed” locations. To further illustrate, pockets of development 331 (e.g., rectangular/right-angle edged polygons) can be seen within the darker areas (hexagons) of high value clusters 325 and 326. Notably, there is development within the white/lighter toned hexagons of low value clusters 328 and 329 (e.g., the development indicated by darker polygons with rectangular/right-angle borders).

However, these may be of relatively lower value. For instance, these areas may have low emergency service priority scores because the areas may already have good wireless network coverage (e.g., average signal strength greater than −110 dBm or the like, low 911 calling history, or a combination of such factors and/or other factors according to an emergency services priority scoring model).

In one example, the emergency services priority score map 310 may be presented via a graphic user interface (GUI). In one example, the GUI may enable a user to select additional views, such as a zoomed-in view (e.g., zoom-in region 320, or the like), to select or de-select various layers (e.g., removing a development layer/overlay, or adding such a layer to the visualization), and so forth. In one example, a processing system of the present disclosure, such as server(s) 199 of FIG. 1, may apply a clustering algorithm to cluster/group two or more adjacent areas into a high-value (or low-value) cluster. In addition, high value (or low value) clusters may be specifically indicated in the emergency services priority score map 310 and/or the visualization of zoom-in region 320, e.g., via circling, via a specific color, via additional highlighting, etc. In addition, in one example, an emergency service priority scoring model may apply additional conditions or criteria to identify high value areas and/or clusters. For example, for an area to be labeled as “high value” it may have a score that exceeds a threshold, e.g., in the example of FIG. 3, greater than 45, greater than 50, or the like.

However, in another example, the scoring model may apply an additional constraint/criterion and/or a user may select an additional constraint/criterion specifying that a high-value area or cluster must be within 10 miles of a police department, fire department, EMS facility, prison, DOJ facility, hospital, town hall, or courthouse. In other words, even if an area has a relatively high score, e.g., greater than 45, greater than 50, or the like, it may not be identified as “high-value” if it fails the additional constraint/criterion. Thus, these and other aspects are all contemplated within the scope of the present disclosure.

FIG. 4 illustrates a flowchart of an example method 400 for performing at least one network configuration action in a wireless communication network based upon at least one emergency service priority score that is assigned to at least one of a plurality of areas within a region in accordance with a scoring model, in accordance with the present disclosure. In one example, steps, functions and/or operations of the method 400 may be performed by a device as illustrated in FIG. 1, e.g., server(s) 199, or any one or more components thereof, such as a processing system, or collectively via a plurality devices in FIG. 1, such as server(s) 199 in conjunction with DB(s) 198, SMO 190, cell sites 121 and 122, BBU pool 126, and so forth. In one example, the steps, functions, or operations of method 400 may be performed by a computing device or system 500, and/or a processing system 502 as described in connection with FIG. 5 below. For instance, the computing device 500 may represent at least a portion of server(s) 199 and/or DB(s) 198 in accordance with the present disclosure. For illustrative purposes, the method 400 is described in greater detail below in connection with an example performed by a processing system, such as processing system 502. The method 400 begins in step 405 and may proceed to step 410.

At step 410, the processing system identifies land coverage characteristics of a plurality of areas within a region. For instance, each of the plurality of areas may comprise a polygon, such as a hexagon of designated size/area, e.g., ½ kilometer per side, or the like. Other examples may use different polygons, such as squares, rectangles, triangles, etc. of different sizes, e.g., ¼ kilometers per side, 1 kilometer per side, etc. The region may comprise a country, such as the entirety of the United States, the continental United States, or lower 48 states, or may comprise a smaller region, such as a state or group of contiguous states, a different country, or sub-regions within other countries, such as states, provinces, counties, etc. In one example, step 410 may include collecting land coverage characteristics from one or more computing systems, such as one or more servers of one or more governmental entities such as described above.

Alternatively, or in addition, step 410 may include retrieving relevant records from a data storage system that is internal or external to the processing system (such as server(s) 199 of FIG. 1 retrieving relevant records from DB(s) 198, or the like). For instance, land coverage characteristics (or data from which the land coverage characteristics may be derived) may have been previously collected and stored in such a database system.

At step 420, the processing system identifies network characteristics of the plurality of areas associated with a wireless communication network, where the network characteristics include wireless signal strength characteristics and emergency service call characteristics. For instance, step 420 may include collecting the network characteristics from one or more network systems, such as an NWDAF, a network repository function (NRF), or the like, or from network elements directly. Alternatively, or in addition, step 420 may include retrieving relevant records from a data storage system that is internal or external to the processing system (such as server(s) 199 of FIG. 1 retrieving relevant records from DB(s) 198, or the like).

At step 430, the processing system assigns a plurality of emergency service priority scores to the plurality of areas. For instance, step 430 may include assigning a respective emergency service priority score to each respective area of the plurality of areas using a scoring model that assigns a first weight to the respective area based upon a respective land coverage characteristic of the respective area and that assigns a second weight to the respective area based upon a respective wireless signal strength characteristic of the respective area and a respective emergency service call characteristic of the respective area. In one example, the respective emergency service priority score may comprise a combination of at least: the first weight and the second weight. To further illustrate, in one example, the respective wireless signal characteristic may comprise an indication of whether the respective area has a wireless signal strength metric than is below a threshold (or above a threshold/the threshold, e.g., −110 dBm, or the like). In addition, the scoring model may assign a weight based upon whether the wireless signal strength metric is below (or above) the threshold, e.g., “20” points if below threshold, zero points if at or above threshold, or the like. In one example, this can be considered a “sub-weight” that is a component of the “second weight.” Similarly, the respective emergency service call characteristic of the respective area may comprise an indication of whether a threshold number of emergency service calls have been initiated by wireless endpoint devices from within the respective area, e.g., within a threshold lookback time period. As noted above, the threshold may be a single 911 call, e.g., at least one call, or could be 2 calls, 5 calls, 10 calls, etc. In one example, a weight may be assigned if a threshold number of calls/zero is below a threshold, such as “4” points (with zero being assigned otherwise) or the like. In one example, this can also be considered a “sub-weight” that is a component of the “second weight.”

In one example, the first weight may be assigned to the respective area in accordance with the scoring model further based upon at least one of: an identification of a designated public structure within the respective area (such as listed in the structure weightings 240 of FIG. 2), a population measure associated with the respective area, a risk index according to a governmental database designation (e.g., according to a FEMA designation or the like), or a presence of at least one road of a designated road type (e.g., a primary and/or secondary road according to a TIGER Database, or the like). For example, designated public structures can have assigned weights according to the scoring model, similarly population can add point to the first weight per the scoring model (e.g., over 2,500 add “1” point, less than 2,500 zero points, etc., or over 5,000 add “2” points, etc.). In one example, points to be added to the first weight are not necessarily linearly proportional to the population metric. In one example, weights from any or all of these characteristics/factors may be considered sub-weights that go into the first weight.

In one example, the network characteristics may further include at least one of: a distance-from-cell site characteristic, a wireless signal strength-plus-land development status characteristic, or a third party wireless performance record characteristic. For instance, the distance-from-cell site characteristic may comprise a distance of the area to a nearest cell site of the wireless communication network. In such an example, the second weight may be further based upon the distance, e.g., zero if closer than 10 miles, “3” points if further than 10 miles from nearest cell site, or the like. In addition, in such an example, the weight assigned for the distance-from-cell site characteristic can also be considered a “sub-weight” that goes into the “second weight.” In one example, the wireless signal strength-plus-land development status characteristic may comprise an indication of whether the respective area has: a developed development status and a wireless signal strength metric that is below a threshold. For instance, the threshold may comprise −110 dBm, or the like, and the status may be “developed” when the respective area has any one of the NLCD developed labels, e.g., developed/open space, developed/low intensity, developed/medium intensity, developed/high intensity. In one example, a weight of “20” points may be assigned if the criterion is met, zero otherwise. In such an example, the second weight may be further based upon the indication. In other words, the weight from the wireless signal strength-plus-land development status characteristic may be considered yet another “sub-weight” that goes into the “second weight.” In one example, the third party wireless performance record characteristic may comprise an indication of whether at least one third party wireless performance record pertaining to the respective area is available to the wireless communication network (e.g., is available to the processing system). In one example, the weight may correspond to the indication, e.g., “10” points if no, zero points if yes, or the like. In one example, a weight base on this characteristic/factor may be considered still another “sub-weight” that goes into the “second weight.” In addition various other characteristics may alternatively or additionally be included in computing the second weight, such as a third party wireless signal strength characteristic/factor as discussed, and so forth.

At step 440, the processing system performs at least one network configuration action in the wireless communication network based upon at least one of the plurality of emergency service priority scores. For instance, the at least one network configuration action may include reconfiguring at least one component of the wireless communication network in response to the at least one of the plurality of emergency service priority scores. For instance, step 440 may include staging at least one software resource at a network edge infrastructure of the wireless communication network proximate to at least one area of the plurality of areas that is associated with the at least one of the plurality of emergency service priority scores, e.g., caching media and/or applications near locations of high importance to public safety. Alternatively, or in addition, step 440 may include establishing a network slice in response to the at least one of the plurality of emergency service priority scores. For instance, the at least one component of the wireless communication network may comprise at least one wireless access network component. To further illustrate, the processing system may activate, deactivate, reassign, or otherwise reconfigure a CU, a DU, a RRH, and/or a BBU, etc. In this regard, it should be noted that reconfiguring can include activating a component, if not active, reassigning to slice, or reallocating priority/time-sharing to the slice (versus other slice(s)) at one or more network components, and so forth.

In one example, the processing system may transmit one or more instructions to one or more components of the RAN, such as a CU, a DU, an RU (or an RRH, BBU, or the like) or to another device or system, such as an SMO, RIC, or the like. The instruction(s) may be to change one or more configurable settings of one or more of such components (which may be considered to be configurable settings of the RAN in which the components are deployed). For instance, the configurable settings can include selection of transmit power, antenna array tilt, beamwidth, etc., selection of precoding techniques, changes to thresholds for UE offloading and/or handover to neighboring cells, activation and deactivation of DUs and RUs, activation and deactivation of CUs, assignment of DUs to one or more CUs, allocation of physical resource, bandwidth, etc. to one or more network slices, and so forth. In one example, step 440 may further include transmitting one or more instructions to one or more other network components, such as an AMF, an NSSF, etc. For instance, reconfigurations of these components may be made in support of a change to at least one aspect of the RAN, such as offloading of UEs to a new network slice that may utilize certain cell sites and not others, and so forth.

In one example, step 440 may include adding, in response to the at least one of the plurality of emergency service priority scores, at least one carrier at a cell site proximate to at least one area of the plurality of areas that is associated with the at least one of the plurality of emergency service priority scores (where proximate may be in or near (e.g., within wireless communication range of) endpoint devices within the at least one area). In still another example, step 440 may alternatively or additionally include adjusting a beam coverage of at least one cell site of the wireless communication network to favor at least one area with an enhanced public safety demand as indicated by the at least one of the plurality of emergency service priority scores (e.g., a score exceeding a threshold, a score exceeding a threshold and within a threshold distance of a designated public safety structure (e.g., within 10 miles of a police station, fire department, EMS facility, DOJ facility, town hall, courthouse, or other designated structure types, or the like)). In one example, the processing system may allocate other resources to “favor” areas with higher scores (and hence greater public safety need/demand (e.g., not currently adequately served by existing network hardware resources and configuration, where higher scores are indicative of “enhanced public safety demand”)). In still another example, the at least one network configuration action of step 440 may comprise rebroadcasting a wireless emergency alert message via a cell site proximate to (e.g., in or near the) at least one area of the plurality of areas that is associated with the at least one of the plurality of emergency service priority scores. For instance, the rebroadcasting is prioritized for the cell site as compared to other cell sites based upon the at least one of the plurality of emergency service priority scores, as discussed above.

At optional step 450, the processing system may position at least one mobile infrastructure component of the wireless communication network at a location proximate to (e.g., in or near) at least one area of the plurality of areas that is associated with the at least one of the plurality of emergency service priority scores. In this case, “near” may be at a location closest in distance or anticipated travel time according to a navigation application where a mobile infrastructure component may be deployed. For instance, the at least one mobile infrastructure component may comprise a cell-on-wheels (CoW) or a generator for cell site operation. In such case, the selection of location may be constrained by available public land, site suitability (e.g., level-ground, paving, ease of access, etc.), site usage and zoning restrictions, local stakeholder preferences, and so forth. It should be noted that in accordance with the present disclosure, a CoW may include a SatCOLT (satellite cell on light truck) or the like. In addition, a generator for cell site operation may comprise a generator that is specifically capable of powering a macro base station, for example. In one example, the positioning of optional step 450 can be in anticipation or prediction of a potential emergency, such as a natural disaster, rather than in response to the occurrence of an actual event. Alternatively, the positioning of step 450 can be in response to an event, where the occurrence of an event is known, but where the impacts are not yet apparent. For instance, the positioning can be in anticipation of where the resources may be most needed (e.g., areas that are underserved by the existing fixed network infrastructure, but where there is a heightened demand, e.g., a developed area, with a public safety facility and/or one or more other facilities of public interest, etc.).

At optional step 460, the processing system may display a map of at least a portion of the region indicating the plurality of emergency service priority scores. For instance, the processing system may generate a map such as illustrated in the example of FIG. 3. In addition, the processing system may display such a map, e.g., via one or more endpoint devices of network personnel, public safety or other governmental entities, etc.

Following step 460, the method 400 may proceed to step 495 where the method ends.

It should be noted that the method 400 may be expanded to include additional steps or may be modified to include additional operations with respect to the steps outlined above. In one example, various steps of the method 400 may be repeated. For instance, cell site location information, wireless signal strength information, population data, and so forth may be updated periodically for purposes of emergency service priority scoring. For example, new macro cell sites may be deployed, populations may change, new public interest facilities may be built, or may move, and so forth. As such, the processing system may periodically repeat steps 410-440, or steps 410-450, steps 410-460, etc., such as bi-monthly, quarterly, etc. In one example, the method 400 may be expanded to further include clustering at least one subset of the plurality of areas based upon a subset of the plurality of emergency service priority scores associated with the at least one subset of the plurality of areas, where the at least one subset comprises contiguous areas of the plurality of area. For instance, the clustering can be supervised, unsupervised, or semi-supervised, and can use a clustering algorithm such as DBScan or the like. For instance, high value areas can be clustered.

Alternatively, or in addition, low value area can be clustered, and so forth. In one example, the “at least one area” mentioned above can be such a “cluster” of areas. In one example, the method 400 may include identifying areas with limited public safety exposure (e.g., low emergency service priority score) and implementing testing of new network configurations or features, where any negative ramifications may have little or no public safety impact. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the example, method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application.

Furthermore, steps, blocks, functions or operations in FIG. 4 that recite a determining operation or involve a decision do not necessarily require that both branches of the determining operation be practiced. In other words, one of the branches of the determining operation can be deemed as an optional step.

Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for performing at least one network configuration action in a wireless communication network based upon at least one emergency service priority score that is assigned to at least one of a plurality of areas within a region in accordance with a scoring model, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, antenna arrays, remote radio heads (RRHs), baseband units (BBUs), transceivers, power units, and so forth.

Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s).

In one example, instructions and data for the present module or process 505 for performing at least one network configuration action in a wireless communication network based upon at least one emergency service priority score that is assigned to at least one of a plurality of areas within a region in accordance with a scoring model (e.g., a software program comprising computer-executable instructions) can be loaded into memory 504 and executed by hardware processor element 502 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for performing at least one network configuration action in a wireless communication network based upon at least one emergency service priority score that is assigned to at least one of a plurality of areas within a region in accordance with a scoring model (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like.

Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, land coverage characteristics of a plurality of areas within a region;
identifying, by the processing system, network characteristics of the plurality of areas associated with a wireless communication network, wherein the network characteristics include wireless signal strength characteristics and emergency service call characteristics;
assigning, by the processing system, a plurality of emergency service priority scores to the plurality of areas, wherein a respective emergency service priority score is assigned to each respective area of the plurality of areas using a scoring model that assigns a first weight to the respective area based upon a respective land coverage characteristic of the respective area and that assigns a second weight to the respective area based upon a respective wireless signal strength characteristic of the respective area and a respective emergency service call characteristic of the respective area, wherein the respective emergency service priority score comprises a combination of at least: the first weight and the second weight; and
performing, by the processing system, at least one network configuration action in the wireless communication network based upon at least one of the plurality of emergency service priority scores.

2. The method of claim 1, wherein the respective wireless signal characteristic comprises an indication of whether the respective area has a wireless signal strength metric that is below a threshold.

3. The method of claim 1, wherein the respective emergency service call characteristic of the respective area comprises an indication of whether a threshold number of emergency service calls has been initiated by wireless endpoint devices from within the respective area.

4. The method of claim 1, wherein the network characteristics further include at least one of:
a distance-from-cell site characteristic;
a wireless signal strength-plus-land development status characteristic; or
a third party wireless performance record characteristic.

5. The method of claim 4, wherein the distance-from-cell site characteristic comprises a distance of a respective area to a nearest cell site of the wireless communication network, wherein the second weight is further based upon the distance.

6. The method of claim 4, wherein the wireless signal strength-plus-land development status characteristic comprises an indication of whether the respective area has: a developed development status and a wireless signal strength metric that is below a threshold, wherein the second weight is further based upon the indication.

7. The method of claim 4, wherein the third party wireless performance record characteristic comprises an indication of whether at least one third party wireless performance record pertaining to the respective area is available to the processing system.

8. The method of claim 1, wherein the at least one network configuration action comprises reconfiguring at least one component of the wireless communication network in response to the at least one of the plurality of emergency service priority scores.

9. The method of claim 8, wherein the reconfiguring comprises:
staging at least one software resource at a network edge infrastructure of the wireless communication network proximate to at least one area of the plurality of areas that is associated with the at least one of the plurality of emergency service priority scores.

10. The method of claim 8, wherein the reconfiguring comprises:
establishing a network slice in response to the at least one of the plurality of emergency service priority scores, wherein the at least one component of the wireless communication network comprises at least one wireless access network component.

11. The method of claim 8, wherein the reconfiguring comprises adding, in response to the at least one of the plurality of emergency service priority scores, at least one carrier at a cell site proximate to at least one area of the plurality of areas that is associated with the at least one of the plurality of emergency service priority scores.

12. The method of claim 8, wherein the reconfiguring comprises adjusting a beam coverage of at least one cell site of the wireless communication network to favor at least one area with an enhanced public safety demand as indicated by the at least one of the plurality of emergency service priority scores.

13. The method of claim 1, wherein the at least one network configuration action comprises rebroadcasting a wireless emergency alert message via a cell site proximate to at least one area of the plurality of areas that is associated with the at least one of the plurality of emergency service priority scores.

14. The method of claim 13, wherein the rebroadcasting is prioritized for the cell site as compared to other cell sites based upon the at least one of the plurality of emergency service priority scores.

15. The method of claim 1, wherein the first weight is assigned to the respective area in accordance with the scoring model further based upon at least one of:
an identification of a designated public structure within the respective area;
a population measure associated with the respective area;
a risk index according to a governmental database designation; or
a presence of at least one road of a designated road type.

16. The method of claim 1, further comprising:
displaying a map of at least a portion of the region indicating the plurality of emergency service priority scores.

17. The method of claim 1, further comprising:
positioning at least one mobile infrastructure component of the wireless communication network at a location proximate to at least one area of the plurality of areas that is associated with the at least one of the plurality of emergency service priority scores.

18. The method of claim 17, wherein the at least one mobile infrastructure component comprises:
a cell-on-wheels; or
a generator for cell site operation.

19. A non-transitory computer-readable medium storing instructions which, when executed by a processing system including at least one processor, cause the processing system to perform operations, the operations comprising:
identifying land coverage characteristics of a plurality of areas within a region;
identifying network characteristics of the plurality of areas associated with a wireless communication network, wherein the network characteristics include wireless signal strength characteristics and emergency service call characteristics;
assigning a plurality of emergency service priority scores to the plurality of areas, wherein a respective emergency service priority score is assigned to each respective area of the plurality of areas using a scoring model that assigns a first weight to the respective area based upon a respective land coverage characteristic of the respective area and that assigns a second weight to the respective area based upon a respective wireless signal strength characteristic of the respective area and a respective emergency service call characteristic of the respective area, wherein the respective emergency service priority score comprises a combination of at least: the first weight and the second weight; and
performing at least one network configuration action in the wireless communication network based upon at least one of the plurality of emergency service priority scores.

20. An apparatus comprising:
a processing system including at least one processor; and
a computer-readable medium storing instructions which, when executed by the processing system, cause the processing system to perform operations, the operations comprising:
identifying land coverage characteristics of a plurality of areas within a region;
identifying network characteristics of the plurality of areas associated with a wireless communication network, wherein the network characteristics include wireless signal strength characteristics and emergency service call characteristics;
assigning a plurality of emergency service priority scores to the plurality of areas, wherein a respective emergency service priority score is assigned to each respective area of the plurality of areas using a scoring model that assigns a first weight to the respective area based upon a respective land coverage characteristic of the respective area and that assigns a second weight to the respective area based upon a respective wireless signal strength characteristic of the respective area and a respective emergency service call characteristic of the respective area, wherein the respective emergency service priority score comprises a combination of at least: the first weight and the second weight; and
performing at least one network configuration action in the wireless communication network based upon at least one of the plurality of emergency service priority scores.
